(19) United States
(12) Patent Application Publication
(10) Pub. No.: US 2014/0185325 A1
(43) Pub. Date: Jul. 3, 2014

(54) LED NIGHT-LIGHT

(71) Applicant: Mary Elle Fashions, Inc., St. Louis, MO (US)

(72) Inventors: Kenneth A. Howard, Creve Coeur, MO (US); Gavin Perry, Webster Groves, MO (US); James J. Riley, St. Louis, MO (US)

(73) Assignee: Mary Elle Fashions, Inc., St. Louis, MO (US)

(21) Appl. No.: 14/139,315

(22) Filed: Dec. 23, 2013

Related U.S. Application Data
(63) Continuation-in-part of application No. 29/441,006, filed on Dec. 29, 2012.
Application No. 29/441,006 is a continuation-in-part of application No. 29/441,007, filed on Dec. 29, 2012.
Application No. 29/441,007 is a continuation-in-part of application No. 29/441,008, filed on Dec. 29, 2012.
(60) Provisional application No. 61/747,274, filed on Dec. 29, 2012.

(51) Int. Cl. F21S 8/00

(52) U.S. Cl. CPC F21S 8/035
USPC 362/641

(57) ABSTRACT

An LED night-light with a switch connected in series with an LED for switching the LED on and off is disclosed. A photo sensor that controls the switch as a function of the ambient light conditions is also disclosed. An LED night-light with a plurality of LEDs for achieving increased light output is also disclosed. An LED night-light using a multilayer chip capacitor to limit the current provided by an alternating current source is also disclosed.

### BACKGROUND

The present invention generally relates to an LED (light-emitting diode) night-light.

### SUMMARY

One aspect comprises a switch connected in series with an LED for switching the LED on and off. A photo sensor may control the switch as a function of the ambient light conditions. Another aspect comprises a plurality of LEDs for achieving increased light output. Another aspect comprises a multilayer chip capacitor to limit the current provided by an alternating current source.

In one aspect, an LED night-light generally comprises first and second prongs configured for insertion into an electrical outlet for connection to an electrical current. A rectifier rectifies the electrical current to provide a direct current. A switch is connected in series with an LED. The direct current passes through the LED to produce light when the switch is in a conductive state and the LED is switched off when the switch is in a second state.

In another aspect, an LED night-light generally comprises first and second prongs configured for insertion into an electrical outlet for connection to an electrical current. A rectifier rectifies the electrical current to provide a direct current. At least two MLCC capacitors are connected to the rectifier for limiting the input current to the rectifier. The rectifier and capacitors thus provide a limited direct current. A switch has a first state and a second state and the limited direct current passes through an LED to produce light when the switch is in the first state and the LED does not produce light when the switch is in the second state.

In yet another aspect, an LED night-light generally comprises first and second prongs configured for insertion into an electrical outlet for connection to an electrical current. A rectifier rectifies the electrical current to provide a direct current. A switch has a first state and a second state. The direct current passes through at least two LEDs to produce light when the switch is in the first state and the LEDs do not produce light when the switch is in the second state.

Other features will be in part apparent and in part pointed out hereinafter.

### BRIEF DESCRIPTION OF THE DRAWINGS

FIG. 1 is a circuit diagram for a night-light.

FIG. 2 is a perspective view of an LED night-light.

FIG. 3 is a circuit diagram for a night-light.

FIG. 4 is a circuit diagram for a night-light.

FIG. 5 is a circuit diagram for a night-light.

FIG. 6 is a circuit diagram for a night-light.

Corresponding reference characters indicate corresponding parts throughout the drawings.

### DETAILED DESCRIPTION

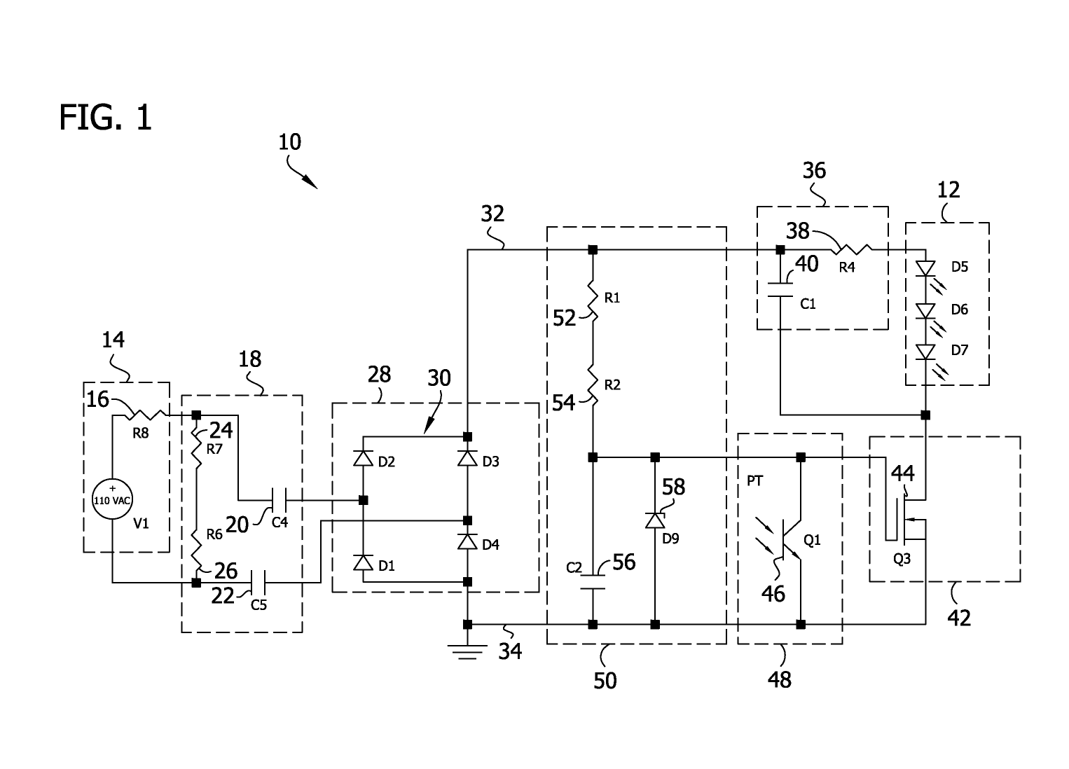

FIG. 1 is a diagram for a circuit 10 for illuminating one or more LEDs shown within dashed box 12. As shown, the LEDs in box 12 can be implemented on a single chip as commonly available part number SMD 5050, as discrete components, or in any other suitable form. For example, the LEDs can be traditional discrete diodes, surface mounted diodes (“SMD”), or any other light emitting diodes, whether discrete or contained in the same package or as part of the same integrated circuit chip. Circuit 10 can be powered by a conventional alternating current source, e.g. 110 VAC, indicated generally within dashed box 14. Box 14 includes a resistor 16 for safety. Resistor 16 may be a 10 Ohm resistor rated for 0.1 W so that, in the event of a malfunction, resistor 16 will act as a fuse and form an open circuit in response to excess current levels.

Dashed box 18 includes capacitors 20 and 22 and resistors 24 and 26. Capacitors 20 and 22 can be implemented as multi-layer chip capacitors (“MLCC”) rated for 680 nF at 100 V. In the configuration shown where they are effectively connected in series, they can handle 200 VAC. Similarly, capacitor 22 could be connected directly to capacitor 20 in series to achieve the same result. By connecting one capacitor 20/22 to each electrical lead from the alternating current source, as shown, there will always be a capacitor between the hot lead and ground, regardless of the polarity of the electrical plug connection between the alternating current source and circuit 10. For circuits where the current source in box 14 provides 220 VAC, a third (and fourth, if needed) capacitor can be used within box 18. Resistors 24 and 26 can be implemented with 1 MOhm (or high kOhm such as 470 kOhm) resistors. Still lower value resistors could be used; however, they will consume more power.

Dashed box 28 includes a conventional rectifier bridge 30 formed from the four diodes shown. Rectifier bridge 30 can be constructed from four discrete diodes or implemented as a single chip in a single package. Rectifier bridge 30 rectifies the conventional alternating current to provide a direct current. Capacitors 20 and 22 are connected to the rectifier bridge 30 for limiting the input current to the rectifier. Rectifier bridge 30 and capacitors 20 and 22 thus provide a limited direct current via lines 32 and 34 that is supplied to the remainder of circuit 10.

The limited direct current is filtered by the filter shown within dashed box 36. Box 36 includes a resistor 38 and a capacitor 40. Resistor 38 can be implemented with a 100 Ohm resistor and capacitor 40 can be implemented with a 22 μF capacitor formed as an MLCC. If cost is a limiting factor, then capacitor 40 can also be implemented as an electrolytic capacitor or any other capacitor that provides suitable capacitance. The filter within box 36 reduces the amount of flicker in the light output of the LEDs shown within box 12. As shown, box 12 includes three LEDs. Circuit 10 can be used to power a greater or lesser number of LEDs provided that the component values are suitably modified as would be understood by a person of ordinary skill in the art. For example, 2 to 10 LEDs, and even up to 20 LEDs, connected in series could be readily energized with circuit 10 as suitably modified for the increased load caused by an increasing number of LEDs.

Dashed box 42 includes an MOS field effect transistor (“MOSFET”) 44 connected in series with the LEDs in box 12. MOSFET 44 may be implemented with a 600V MOSFET, part number BSS127, available from Infineon Technologies or Diodes, Inc. (BSS127SSN). MOSFET 44 serves as a switch for turning the power on and off to the LEDs in box 12. The gate of MOSFET 44 is connected to a phototransistor 46 within dashed box 48. Phototransistor 46 can be implemented with Everlight Electronics part number PT 19-21C. When sufficient ambient light strikes phototransistor 46, it conducts and reduces the voltage between the gate and the source of MOSFET 44. This causes MOSFET 44 to be non-conductive and switches off the power to the LEDs in box 12. When insufficient ambient light strikes the phototransistor 46, it becomes an open circuit such that the voltage provided by a voltage reference circuit shown in dashed box 50 is applied to the gate of MOSFET 44. This renders MOSFET 44 conductive and turns on the power to the LEDs in box 12.

The voltage reference circuit shown in box 50 includes resistors 52 and 54 that can be implemented with 2 MOhm resistors. A capacitor 56 is connected in parallel with a zener diode 58. Capacitor 56 can be implemented with a 100 nF capacitor formed as an MLCC. Diode 58 can be implemented with a 12V zener diode. As shown, resistors 52 and 54 are connected in series with the parallel capacitor 56 and zener diode 58 forming a 12V reference for the gate of MOSFET 44.

The voltage reference circuit shown within box 50 and the phototransistor 46 provide suitable on and off states for MOSFET 44 in many ambient light conditions. A person skilled in the art would understand how to add additional circuitry within dashed boxes 48 and 50 to provide sharper on and off states for MOSFET 44 as may be needed for some ambient light conditions. Other electronic switches could also be used in place of MOSFET 44, such as a bipolar NPN transistor, or the like, to switch the power on and off to the LEDs in box 12.

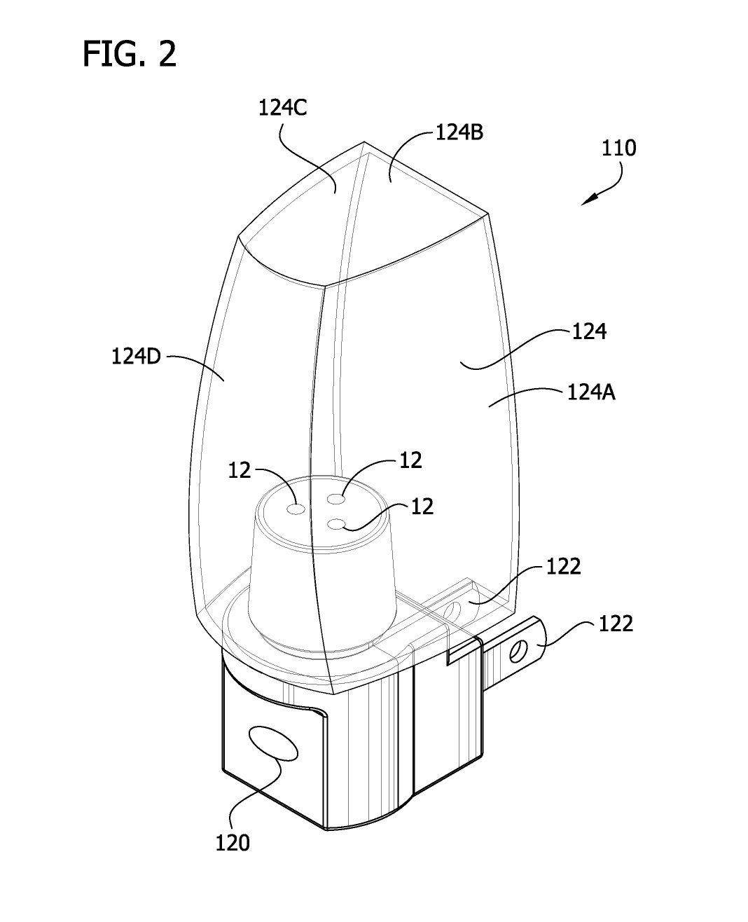

FIG. 2 shows a night-light 110. Three LEDs 12 (corresponding to the LEDs shown in box 12 in FIG. 1) provide the light output. Any number of LEDs may be used depending on the amount of light needed. For example, 3 to 5 LEDs could be used. If more light is desired, then 3 to 10 LEDs could be used. For even more light output, 20 LEDs could be used. A person skilled in the art would understand how to modify the component values for circuits 10, 200, 300, 400 and 500 in FIGS. 1, 3, 4, 5, and 6, respectively, to power the desired number of LEDs.

FIG. 2 includes a lens 120 that passes ambient light to a phototransistor, such as phototransistor 46 in FIG. 1, for switching the power on and off to LEDs 12 as a function of the ambient light. AC power is supplied through a conventional electrical outlet via conductors 122. This AC power corresponds to the AC power source shown in box 14 of FIG. 1. Conductors 122 can be suitably dimensioned for a friction fit with an electrical outlet such that the weight of the night light fixture is supported and held in position thereby. In the event that it is desired to manually switch the night-light 110 on and off, then a manual switch could be positioned in place of lens 120 and the manual switch would be electrically connected to switch on and off the AC power. Alternatively, the manual switch could be electrically connected in place of MOSFET 44 in FIG. 1 (rendering the rest of the circuitry shown in boxes 48 and 50 unnecessary as well) to manually switch on and off the power to LEDs 12.

Night-light 110 includes a shade 124. In the aspect shown, shade 124 includes right side 124A, top 124B, left side 124C and front 124D. Shade 124 may be formed in any suitable shape and manner from any suitable material. Shade 124 may have at least one portion formed as a transparent material with an applique covering its surface where the applique presents a desired image or design.

Shade 124 may also be formed as an artistic piece with regions that are substantially opaque, regions that are substantially transparent, regions that are partially transparent, or a combination of regions that are opaque, transparent and/or partially transparent. In this manner, shade 124 may present an image or design that is illuminated by LEDs 12 having a varying intensity of light emitted from shade 124. To the extent shade 124 passes less light, then more LEDs 12 may be desirable, and vice versa. The term “opaque” as used herein means blocking 80% or more of the light striking an inside surface of the shade 124. The term “transparent” as used herein means passing 80% or more of the light striking an inside surface of the shade 124. The term “partially transparent” as used herein means passing 40% to 60% of the light striking an inside surface of the shade 124. The number of LEDs may be coordinated with the intensity of light which is transmitted through the shade 124 to provide a predetermined light output through the shade. For example, if about 60% of the light is transmitted through the shade 124, three LEDs may be used. If less than 60% of light is transmitted, four or more LEDs may be used. If greater than 60% is transmitted, two or fewer LEDs may be used. Of course, more generally, any number of LEDs can be used and any desired light output and illumination effect from the shade can be achieved with the circuitry and shade parameters disclosed herein—depending on the desired color, intensity, illumination, shade transmissibility, shade design, shade shape, artistic effect, or any other aspect that affects the light output or appearance.

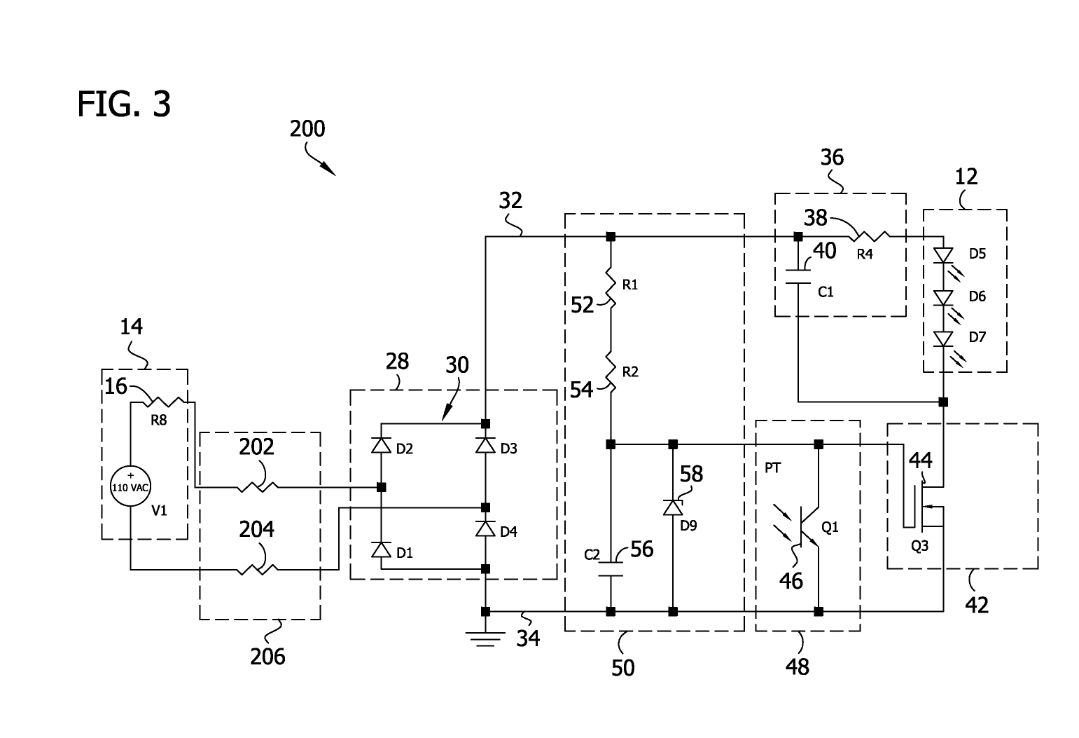

FIG. 3 is a diagram for a circuit 200 for illuminating one or more LEDs shown within dashed box 12. There are many common features and components between circuit 200 and circuit 10 in FIG. 1 described above. Common features and common components (with common reference numbers) will be summarily described here for brevity.

Circuit 200 includes resistors 202 and 204 within a dashed box 206. When illuminating three LEDs, resistors 202 and 204 can have a value of 10 kOhm. Resistors 202 and 204 limit the current supplied to the rectifier bridge 30, and thus limit the current to an appropriate level for illuminating the LEDs in box 12.

In operation, the alternating current from the source within box 14 in FIG. 3 is rectified by the rectifier bridge 30 to provide a direct current on lines 32 and 34. Resistors 202 and 204 limit the current level. Thus, resistors 202 and 204 and rectifier bridge 30 provide a limited direct current on lines 32 and 34. This limited direct current is filtered by the filter within box 36 and then illuminates the three LEDs within dashed box 12 during periods of time when MOSFET 44 is in a conductive state. Phototransistor 46 is connected to the gate of MOSFET 44 and, as with circuit 10 in FIG. 1, controls whether MOSFET 44 is in a first conductive state or a second state where it is not conductive. The voltage reference circuit within box 50 is the same as the circuit in box 50 in FIG. 1 and sets the voltage applied to the gate of MOSFET 44 during periods of time when the ambient light level striking phototransistor 46 is low.

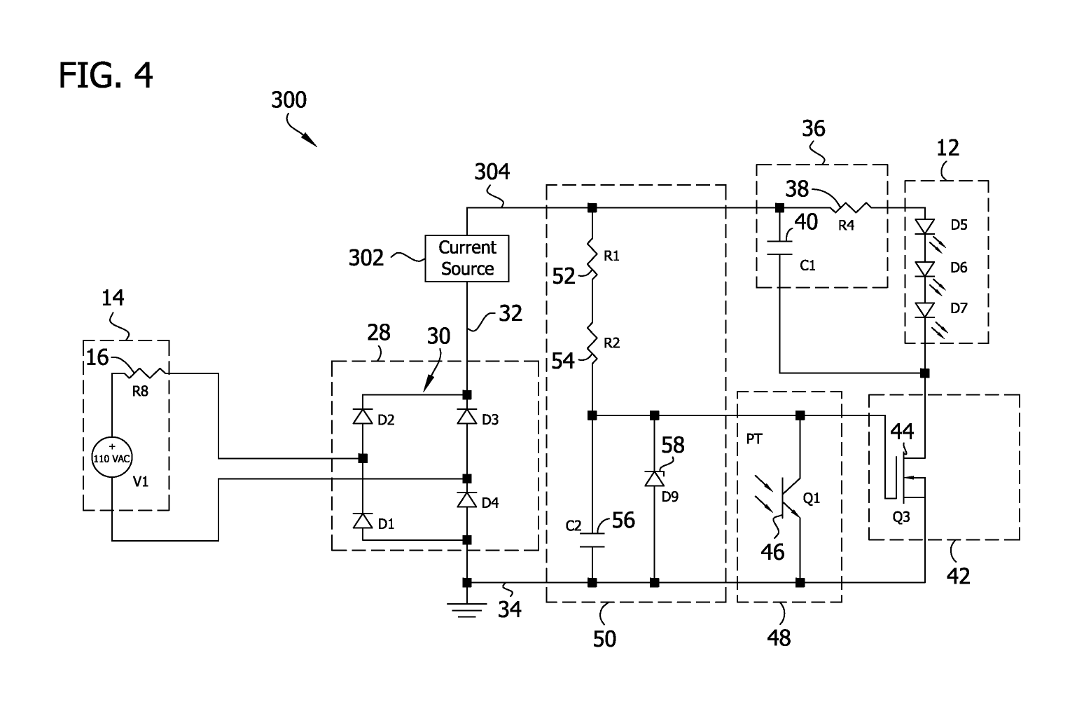

FIG. 4 is a diagram for a circuit 300 for illuminating one or more LEDs shown within box 12. There are many common features and components between circuit 300 and circuit 10 in FIG. 1 described above. Common features and common components (with common reference numbers) will be summarily described here for brevity.

Circuit 300 includes a current source 302 that can take the form of a common integrated circuit or discrete components in a common layout for supplying a desired current level for illuminating the three LEDs in dashed box 12. Additional capacitance can be added to the current source 302 if desired for a smoother current level. The remainder of circuit 300 functions as described above for the common components in circuit 10 in FIG. 1.

In operation, the alternating current from the source within box 14 in FIG. 4 is rectified by the rectifier bridge to provide a direct current on lines 32 and 34. The current source 302 sets the desired current level output on line 304. This limited direct current is then filtered by the filter within box 36 and then illuminates the three LEDs within box 12 during periods of time when MOSFET 44 is in a conductive state. Phototransistor 46 is connected to the gate of MOSFET 44 and, as with circuit 10 in FIG. 1, controls whether MOSFET 44 is in a first conductive state or a second state where it is not conductive. The voltage reference circuit within box 50 is the same as circuit 50 in FIG. 1 and sets the voltage applied to the gate of MOSFET 44 during periods of time when the ambient light level striking phototransistor 46 is low.

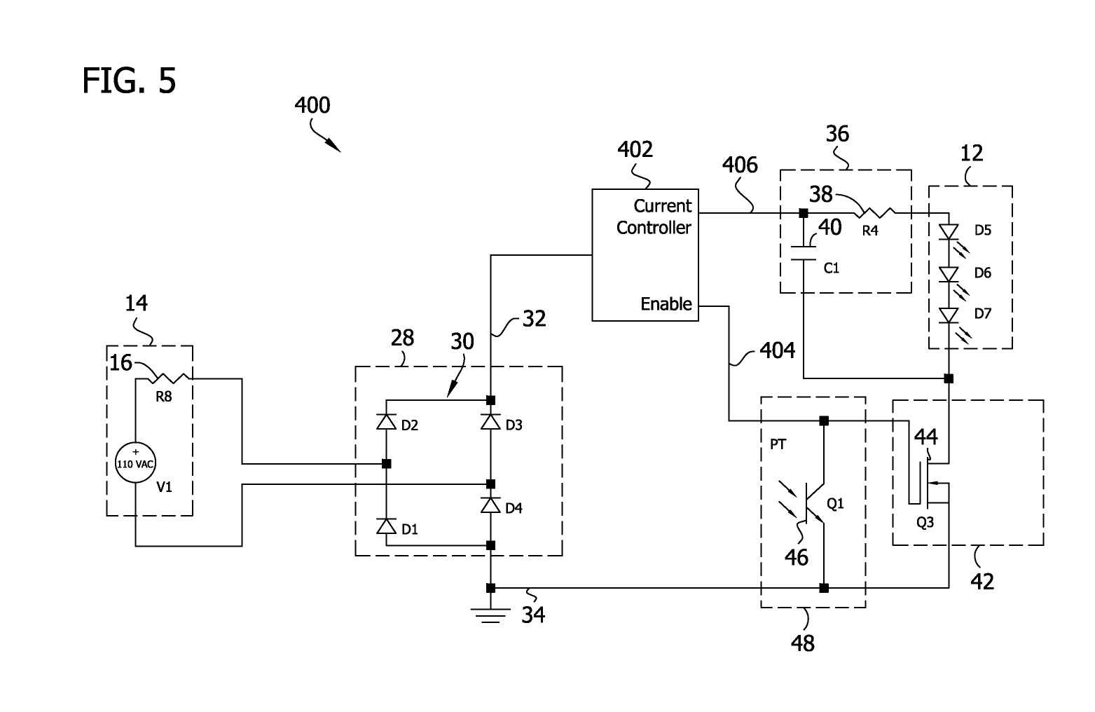

FIG. 5 is a diagram for a circuit 400 for illuminating one or more LEDs shown within box 12. There are many common features and components between circuit 400 and circuit 10 in FIG. 1 described above. Common features and common components (with common reference numbers) will be summarily described here for brevity.

Circuit 400 includes a current controller 402 that can take the form of a common integrated circuit or custom integrated circuit for supplying a desired current level for illuminating the three LEDs in box 12. Current controller 402 responds to phototransistor 46 via a line 404 and the ENABLE pin. During periods of time when the ambient light level striking phototransistor 46 is low, the ENABLE pin is isolated from ground level voltage and the current controller 402 supplies current for illuminating the LEDs within box 12. During periods of time when the ambient light level striking phototransistor 46 is high, phototransistor 46 becomes conductive and grounds the ENABLE pin via line 404. In this state, current controller 402 does not supply current to the LEDs in box 12. The rectifier bridge 30 and the filter within box 36 function the same as the common components in circuit 10 in FIG. 1. Phototransistor 46 can be implemented as a discrete component or, as with many components disclosed herein, can be formed as part of the integrated circuit comprising current controller 402.

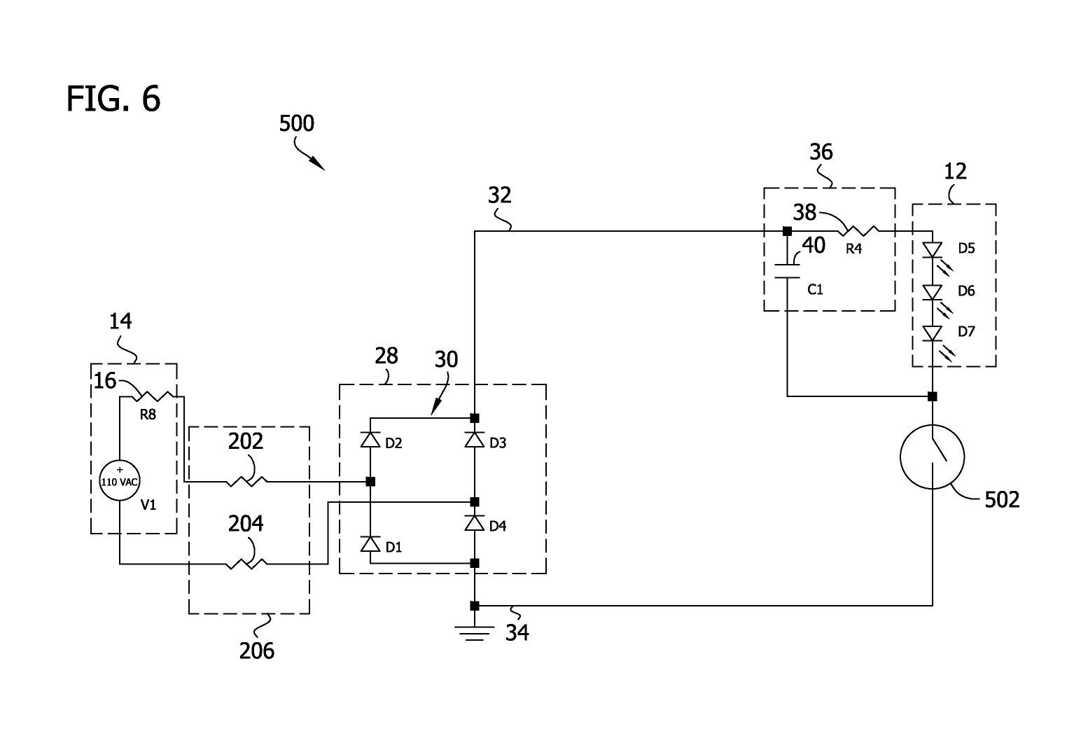

FIG. 6 is a diagram for a circuit 500 for illuminating one or more LEDs shown within box 12. Common features and components with common reference numbers between circuit 500 and circuit 10 in FIG. 1 above will be summarily described here for brevity.

Circuit 500 includes resistors 202 and 204 within a dashed box 206. When illuminating three LEDs, resistors 202 and 204 can have a value of 10 kOhm. Resistors 202 and 204 limit the current supplied to the rectifier bridge 30, and thus limit the current to an appropriate level for illuminating the LEDs in box 12.

In operation, the alternating current from the source within box 14 in FIG. 6 is rectified by the rectifier bridge to provide a direct current on lines 32 and 34. Resistors 202 and 204 limit the current level. Thus, resistors 202 and 204 and rectifier bridge 30 provide a limited direct current on lines 32 and 34. This limited direct current is filtered by the filter within box 36 and then illuminates the three LEDs within dashed box 12 during periods of time when a manual switch 502 is in a conductive state. When manual switch 502 is positioned in a non-conductive state, the LEDs in box 12 are not illuminated. Thus, manual switch 502 allows the user to manually control the turning on and off of the LEDs in box 12.

By comparing circuit 200 in FIG. 3 with circuit 500 in FIG. 6, it is seen that circuit 200 turns the LEDs on and off as a function of the ambient light level and circuit 500 turns the LEDs on and off as a function of the position of manual switch 502. Thus, for manual control, manual switch 502 is connected between the LEDs and ground. For ambient light control, manual switch 502 is not used—rather, MOSFET 44, phototransistor 46, and the voltage reference circuit within box 50 are used instead. Circuit 10 in FIG. 1 and circuit 300 in FIG. 4 could be similarly modified with a manual switch 502 in place of MOSFET 44, phototransistor 46, and the voltage reference circuit within box 50 for manual control of the illumination of the LEDs in box 12. Likewise, manual switch 502 could replace phototransistor 46 in circuit 400 in FIG. 5 if manual control of the LED illumination there was desired.

Circuits 10, 200, 300, 400 and 500 in FIGS. 1, 3, 4, 5 and 6, respectively, can be used to power a greater or lesser number of LEDs provided that the component values are suitably modified as would be understood by a person of ordinary skill in the art. For example, 2 to 10 LEDs, and even up to 20 LEDs, connected in series could be readily energized with circuits 10, 200, 300, 400 and 500 as suitably modified for the increased load caused by an increasing number of LEDs.

While particular part numbers, component values and structures have been disclosed for circuits 10, 200, 300, 400 and 500, a person of skill in the art could readily vary these components to achieve proper illumination of the LEDs contemplated for use. These circuits can be implemented with discrete components, with custom integrated circuits, or with any other components available to those skilled in the art.

The Abstract and Summary are provided to help the reader quickly ascertain the nature of the technical disclosure. They are submitted with the understanding that they will not be used to interpret or limit the scope or meaning of the claims.

The Summary is provided to introduce a selection of concepts in simplified form that are further described in the Detailed Description. The Summary is not intended to identify key features or essential features of the claimed subject matter, nor is it intended to be used as an aid in determining the claimed subject matter.

Having described aspects of the invention in detail, it will be apparent that modifications and variations are possible without departing from the scope of the invention defined in the appended claims.

When introducing and explaining aspects of the disclosure, the articles “a”, “an”, “the” and “said” are intended to mean that there are one or more of the elements. The terms “comprising”, “including” and “having” are intended to be inclusive and mean that there may be additional elements other than the listed elements.

The above description illustrates aspects of the invention by way of example and not by way of limitation. This description enables one skilled in the art to make and use aspects of the invention, and describes several embodiments, aspects, adaptations, variations, alternatives and uses of the invention, including what is presently believed to be the best mode of carrying out the invention. Additionally, it is to be understood that the invention is not limited in its application to the details of construction and the arrangement of components set forth in this description or illustrated in the drawings. The invention is capable of other embodiments and aspects, and of being practiced or carried out in various ways. Also, it will be understood that the phraseology and terminology used herein is for the purpose of description and should not be regarded as limiting.

As various changes could be made in the above constructions and methods without departing from the scope of the invention, it is intended that all matter contained in the above description and shown in the accompanying drawings shall be interpreted as illustrative and not in a limiting sense.

1. An LED night-light comprising:
first and second prongs configured for insertion into an electrical outlet for connection to an electrical current;
a rectifier for rectifying the electrical current to provide a direct current;
a switch;
an LED connected in series with the switch;
wherein the direct current passes through the LED to produce light when the switch is in a conductive state and wherein the LED is switched off when the switch is in a second state.

2-46. (canceled)

47. The LED night-light of claim 1 wherein the switch comprises at least one of (1) a field effect transistor, (2) a bipolar transistor and a MOSFET, and (3) a bipolar transistor.

48. The LED night-light of claim 47 further comprising at least one of:
a capacitor connected to the rectifier for limiting the input current to the rectifier; and
at least two MLCC capacitors connected to the rectifier for limiting the input current to the rectifier.

49. The LED night-light of claim 1 wherein the switch is at least one of:
a manual switch; and
a switch responsive to a phototransistor for switching the switch between the conductive state and the second state as a function of an ambient light condition.

50. The LED night-light of claim 1 further comprising at least one of:
two to 20 LEDs;
three to 10 LEDs; and
three to 20 LEDs.

51. The LED night-light of claim 1 further comprising at least one of:
a shade having a region that is partially transparent, a region that is transparent, and a region that is opaque wherein the shade is illuminated when the LED produces light;
a shade having a region that is partially transparent and a region that is opaque wherein the shade is illuminated when the LED produces light; and
a shade having a region that is partially transparent and two to 20 LEDs connected to the switch to provide a predetermined light output through the shade.

52. The LED night-light of claim 51 further comprising at least two MLCC capacitors connected to the rectifier for limiting the input current to the rectifier.

53. An LED night-light comprising:
first and second prongs configured for insertion into an electrical outlet for connection to an electrical current;
a rectifier for rectifying the electrical current to provide a direct current;
at least two MLCC capacitors connected to the rectifier for limiting the input current to the rectifier;
wherein the rectifier and the at least two MLCC capacitors provide a limited direct current;
an LED;
a switch having a first state and a second state;
wherein the limited direct current passes through the LED to produce light when the switch is in the first state and wherein the LED does not produce light when the switch is in the second state.

54. The LED night-light of claim 53 wherein at least one of the following:
the switch comprises a field effect transistor;
the switch comprises a bipolar transistor;
the switch is responsive to a phototransistor for switching the switch between the first state and the second state as a function of an ambient light condition, and wherein the switch is connected in series with the LED;
the switch comprises a MOSFET connected in series with the LED; and
the switch is a manual switch.

55. The LED night-light of claim 53 further comprising at least ONE of:
two to 20 LEDs;
three to 10 LEDs; and
three to 10 LEDs.

56. The LED night-light of claim 53 further comprising at least one of:
a shade having a region that is partially transparent.
a shade having a region that is partially transparent, a region that is transparent, and a region that is opaque.
a shade having a region that is partially transparent.
a shade having a region that is partially transparent and a region that is opaque.

57. An LED night-light comprising:
first and second prongs configured for insertion into an electrical outlet for connection to an electrical current;
a rectifier for rectifying the electrical current to provide a direct current;
at least two LEDs;
a switch having a first state and a second state;
wherein the direct current passes through the LEDs to produce light when the switch is in the first state and wherein the LEDs do not produce light when the switch is in the second state.

58. The LED night-light of claim 57 wherein the switch comprises a field effect transistor, or bipolar transistor, or a MOSFET.

59. The LED night-light of claim 57 further comprising at least one of:
a capacitor connected to the rectifier for limiting the input current to the rectifier; and
at least two MLCC capacitors connected to the rectifier for limiting the input current to the rectifier.

60. The LED night-light of claim 57 wherein the switch is a manual switch or wherein the switch is responsive to a phototransistor for switching the switch between the first state and the second state as a function of an ambient light condition.

61. The LED night-light of claim 57 further comprising two to 20 LEDs or three to 20 LEDs.

62. The LED night-light of claim 57 further comprising at least one of the following:
a shade having a region that is partially transparent, a region that is transparent, and a region that is opaque, wherein the shade is illuminated when the LED produces light;
a shade having a region that is partially transparent and a region that is opaque, wherein the shade is illuminated when the LED produces light; and
a shade having a region that is partially transparent and two to 20 LEDs connected to the switch to provide a predetermined light output through the shade.

63. The LED night-light of claim 67 wherein the switch comprises a field effect transistor or bipolar transistor or a MOSFET and further comprising a capacitor connected to the rectifier for limiting the input current to the rectifier.

64. The LED night-light of claim 63 wherein the capacitor comprises at least two MLCC capacitors connected to the rectifier for limiting the input current to the rectifier.

65. The LED night-light of claim 60 wherein the switch is responsive to a phototransistor for switching the switch between the first state and the second state as a function of an ambient light condition and wherein the switch comprises a field effect transistor, a bipolar transistor or a MOSFET.
